(19) United States
(12) Patent Application Publication
(10) Pub. No.: US 2022/0413767 A1
(43) Pub. Date: Dec. 29, 2022

(54) INFORMATION PROCESSING DEVICE, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/822,806

(22) Filed: Aug. 29, 2022

Related U.S. Application Data
(63) Continuation of application No. PCT/JP2020/038132, filed on Oct. 8, 2020.

(30) Foreign Application Priority Data
Mar. 18, 2020 (JP) 2020-048439

(51) Int. Cl. G06F 3/06

(52) U.S. Cl. CPC G06F 3/0659; G06F 3/0604; G06F 3/0686

(57) ABSTRACT

An information processing device performs control to record, out of a plurality of pieces of data to be recorded on a plurality of magnetic tapes, a data group in which a value corresponding to a size of a data group for which a storage period is within a predetermined range is equal to or more than a threshold value and a data group in which the value is less than the threshold value, on magnetic tapes different from each other.

### CROSS-REFERENCE TO RELATED APPLICATIONS

This application is a continuation application of International Application No. PCT/JP2020/038132, filed on Oct. 8, 2020, the disclosure of which is incorporated herein by reference in its entirety. Further, this application claims priority from Japanese Patent Application No. 2020-048439, filed on Mar. 18, 2020, the disclosure of which is incorporated herein by reference in its entirety.

### BACKGROUND

### 1. Technical Field

The present disclosure relates to an information processing device, an information processing method, and an information processing program.

### 2. Description of the Related Art

A technique of recording data on a magnetic tape in the order from data having a long remaining data storage period to data having a short remaining data storage period is disclosed (see JP2011-164867A).

### SUMMARY

In the technique disclosed in JP2011-164867A, the remaining data on the same magnetic tape can be normally accessed even in a case where data for which the storage period is expired is deleted, but it is not considered that new data is recorded in a free area in which the data is deleted.

In a case where data is recorded in a free area in accordance with a rule that data is recorded in the order from data having a long remaining storage period to data having a short remaining storage period, the number of pieces of data having a shorter remaining storage period than the storage period of data that has been recorded on the magnetic tape is getting smaller with the passage of time. Therefore, at least a part of the free area may remain a free area, and the magnetic tape cannot be efficiently used.

On the other hand, in a case where the above-described rule is ignored and data is recorded in the free area, data having a longer remaining storage period than the storage period of the recorded data is recorded in the free area. In this case, since the time when the data on the magnetic tape can be deleted is the time when the storage period of all the data recorded in the free area is expired, it is necessary to wait for a long period of time in order to reuse the magnetic tape. Accordingly, the magnetic tape cannot be efficiently used.

The present disclosure has been made in view of the above circumstances, and an object of the present disclosure is to provide an information processing device, an information processing method, and an information processing program capable of efficiently using a magnetic tape.

According to the present disclosure, there is provided an information processing device comprising: at least one processor, in which the processor performs control to record, out of a plurality of pieces of data to be recorded on a plurality of magnetic tapes, a data group in which a value corresponding to a size of a data group for which a storage period is within a predetermined range is equal to or more than a threshold value and a data group in which the value is less than the threshold value, on magnetic tapes different from each other.

In the information processing device of the present disclosure, the processor may perform, in a case where there are a plurality of the data groups in which the value is equal to or more than the threshold value, control to record the plurality of data groups on magnetic tapes different from each other, respectively.

Further, in the information processing device of the present disclosure, the value corresponding to the size of the data group may be a total value of the size of the data group for which the storage period is within the range or a ratio of the total value of the size of the data group for which the storage period is within the range to a total value of sizes of the plurality of pieces of data.

Further, in the information processing device of the present disclosure, the processor may set the threshold value according to a total value of sizes of the plurality of pieces of data.

Further, in the information processing device of the present disclosure, the processor may perform, for a data group having a size of which a total value is equal to or more than a second threshold value which is greater than the threshold value, out of the data group in which the value is equal to or more than the threshold value, control to narrow the range and to record the data group on the plurality of magnetic tapes.

Further, in the information processing device of the present disclosure, the processor may perform, for a data group having a size of which the total value corresponds to a capacity of the plurality of magnetic tapes, out of the data group in which the value is equal to or more than the threshold value, control to divide and record the data group on the plurality of magnetic tapes.

Further, according to the present disclosure, there is provided an information processing method executed by a processor provided in an information processing device, the method comprising: performing control to record, out of a plurality of pieces of data to be recorded on a plurality of magnetic tapes, a data group in which a value corresponding to a size of a data group for which a storage period is within a predetermined range is equal to or more than a threshold value and a data group in which the value is less than the threshold value, on magnetic tapes different from each other.

Further, according to the present disclosure, there is provided an information processing program for causing a processor provided in an information processing device to execute a process comprising: performing control to record, out of a plurality of pieces of data to be recorded on a plurality of magnetic tapes, a data group in which a value corresponding to a size of a data group for which a storage period is within a predetermined range is equal to or more than a threshold value and a data group in which the value is less than the threshold value, on magnetic tapes different from each other.

According to the present disclosure, a magnetic tape can be efficiently used.

### BRIEF DESCRIPTION OF THE DRAWINGS

FIG. 1 is a block diagram showing an example of a configuration of a recording and reproducing system.

FIG. 2 is a block diagram showing an example of a hardware configuration of an information processing device.

FIG. 3 is a diagram illustrating a storage period of data.

FIG. 4 is a diagram illustrating an example of a plurality of pieces of data to be recorded.

FIG. 5 is a block diagram showing an example of a functional configuration of the information processing device.

FIG. 6 is a diagram illustrating a total value of a size of a data group for each predetermined range.

FIG. 7 is a diagram illustrating a magnetic tape of a recording destination for each data group.

FIG. 8 is a flowchart showing an example of data recording processing.

FIG. 9 is a diagram illustrating a magnetic tape of a recording destination of a data group according to a modification example.

### DETAILED DESCRIPTION

Hereinafter, examples of embodiments of the technique of the present disclosure will be described in detail with reference to the drawings.

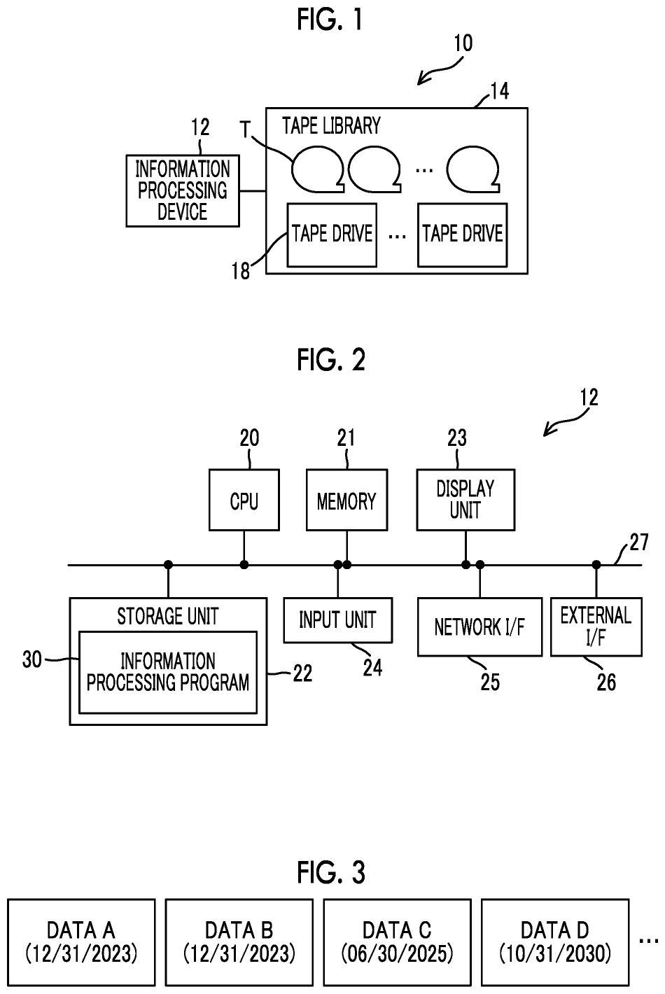

First, a configuration of a recording and reproducing system 10 according to the present embodiment will be described with reference to FIG. 1. As shown in FIG. 1, the recording and reproducing system 10 includes an information processing device 12 and a tape library 14.

The tape library 14 comprises a plurality of slots (not shown) and a plurality of tape drives 18, and a magnetic tape T as an example of a recording medium is stored in each slot. Each tape drive 18 is connected to the information processing device 12. The tape drive 18 writes or reads data with respect to the magnetic tape T under the control of the information processing device 12. An example of the magnetic tape T includes a linear tape-open (LTO) tape.

In a case where the information processing device 12 writes or reads data with respect to the magnetic tape T, the magnetic tape T to be written or to be read is loaded from the slot into the predetermined tape drive 18. In a case where the writing or reading of data with respect to the magnetic tape T loaded in the tape drive 18 is completed, the magnetic tape T is unloaded from the tape drive 18 to the originally stored slot.

Next, a hardware configuration of the information processing device 12 according to the present embodiment will be described with reference to FIG. 2. As shown in FIG. 2, the information processing device 12 includes a central processing unit (CPU) 20, a memory 21 serving as a temporary storage area, and a non-volatile storage unit 22. In addition, the information processing device 12 includes a display unit 23, such as a liquid crystal display, an input unit 24, such as a keyboard and a mouse, a network interface (I/F) 25 connected to a network, and an external I/F 26 to which each tape drive 18 is connected. The CPU 20, the memory 21, the storage unit 22, the display unit 23, the input unit 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 serving as a storage medium. The CPU 20 reads out the information processing program 30 from the storage unit 22 and then develops the information processing program 30 into the memory 21, and executes the developed information processing program 30. An example of the information processing device 12 includes a server computer.

Further, the storage unit 22 stores a plurality of pieces of data to be recorded on a plurality of magnetic tapes T. As shown in FIG. 3, for each of the plurality of pieces of data to be recorded, the storage period of the data is set. In the present embodiment, the storage period indicates the date when the data needs to be stored. That is, data for which the storage period is expired may be deleted. The remaining period until the date when the data needs to be stored may be applied as the storage period. In this case, the storage period is periodically updated.

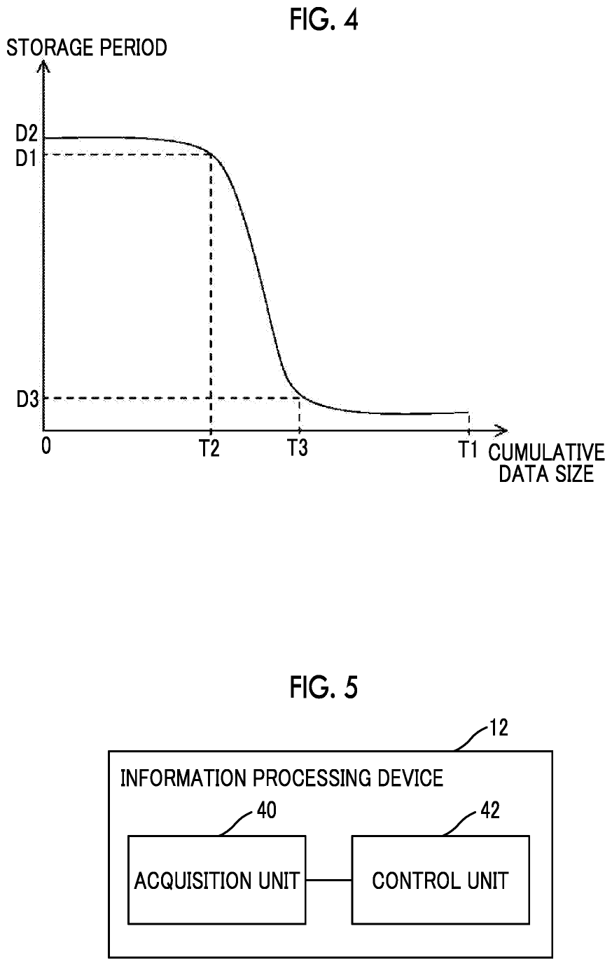

FIG. 4 shows an example of a relationship between the storage period and the sizes of a plurality of pieces of data to be recorded. The vertical axis of FIG. 4 represents the storage period, and the horizontal axis represents the cumulative data size. That is, T1 in FIG. 4 represents the total value of the sizes of all the plurality of pieces of data to be recorded. Further, T2 in FIG. 4 represents the total value of the size of a data group for which the storage period is from D1 to D2. Further, (T3-T2) in FIG. 4 represents the total value of the size of a data group for which the storage period is from D3 to D1. The graph of FIG. 4 shows that a data group for which the storage period is before D3 and the data group for which the storage period is from D1 to D2 have a relatively large size per unit period, and the data for which the storage period is from D3 to D1 has a relatively small size per unit period.

Next, a functional configuration of the information processing device 12 according to the present embodiment will be described with reference to FIG. 5. As shown in FIG. 5, the information processing device 12 includes an acquisition unit 40 and a control unit 42. The CPU 20 executes the information processing program 30 to function as the acquisition unit 40 and the control unit 42.

The acquisition unit 40 acquires a plurality of pieces of data to be recorded on the plurality of magnetic tapes T, from the storage unit 22.

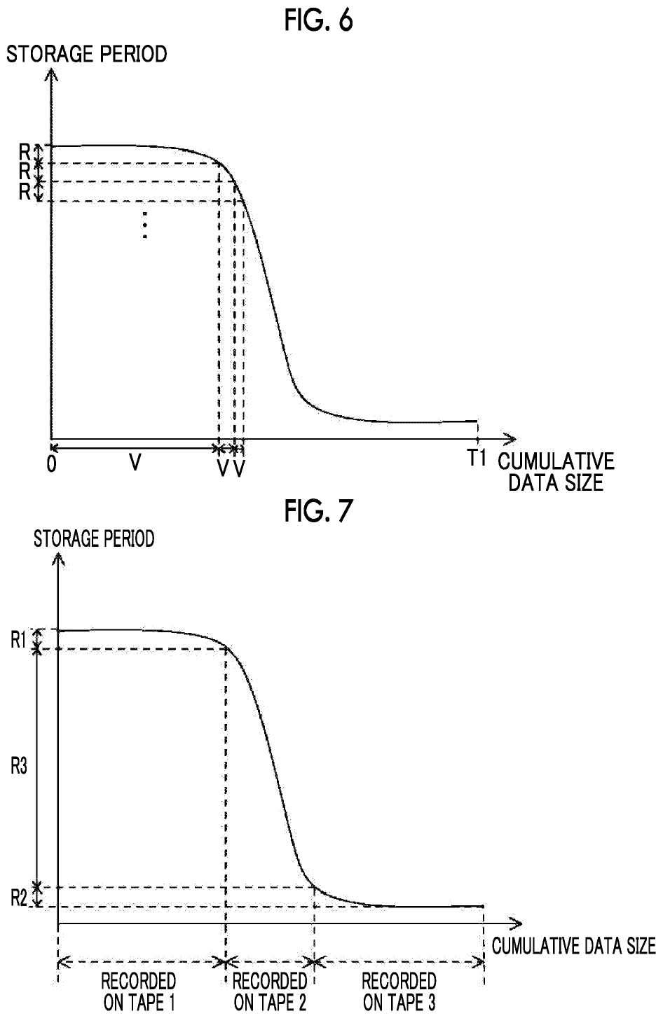

The control unit 42 performs control to record, out of the plurality of pieces of data to be recorded acquired by the acquisition unit 40, a data group in which a value V corresponding to the size of a data group for which the storage period is within a predetermined range R is equal to or more than a threshold value TH1 and a data group in which the value V is less than the threshold value TH1, on magnetic tapes T different from each other. Further, the control unit 42 performs, in a case where there are a plurality of the data groups in which the value V is equal to or more than the threshold value TH1, control to record the plurality of data groups on magnetic tapes T different from each other, respectively. In the present embodiment, an example in which the total value of the size of the data group for which the storage period is within the range R is applied as the value V will be described. Hereinafter, the control performed by the control unit 42 will be described in detail with reference to FIGS. 6 and 7.

As shown in FIG. 6, the control unit 42 divides the storage period into each range R (for example, one month), and derives the total value of the size of the data group for which the storage period is within the range R, as the value V, for each range R. Here, as shown in FIG. 7 as an example, a case where values V derived for a range R1 and a range R2 each are equal to or more than the threshold value TH1 and a value derived for each range R except for the range R1 and the range R2 is less than the threshold value TH1 will be described. In FIG. 7, a range obtained by combining respective ranges R except for the range R1 and the range R2 is represented as a range R3.

As shown in FIG. 7, the control unit 42 performs control to record a data group for which the storage period is within the range R1 and a data group for which the storage period is within the range R2, in which the values V each are equal to or more than the threshold value TH1, and a data group for which the storage period is within the range R3, in which the value V is less than the threshold value TH1, on magnetic tapes T different from each other. Further, since there are two data groups, that is, the data group for which the storage period is within the range R1 and the data group for which the storage period is within the range R2, in which the values V each are equal to or more than the threshold value TH1, the control unit 42 performs control to record the data group for which the storage period is within the range R1 and the data group for which the storage period is within the range R2, on magnetic tapes T different from each other. Accordingly, in this case, as shown in FIG. 7, the data groups for which the storage periods are within the range R1 to R3 are recorded on three magnetic tapes T different from each other, respectively.

For example, a value corresponding to the capacity of the magnetic tape T, such as a size of 80% of the capacity of the magnetic tape T, can be applied as the threshold value TH1.

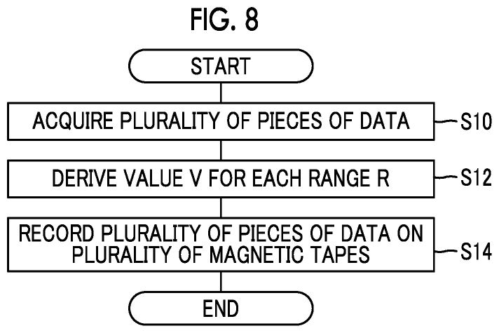

Next, the action of the information processing device 12 according to the present embodiment will be described with reference to FIG. 8. The CPU 20 executes the information processing program 30, whereby data recording processing shown in FIG. 8 is executed. The data recording processing shown in FIG. 8 is executed, for example, in a case where an execution instruction is input by a user via the input unit 24.

In step S10 of FIG. 8, the acquisition unit 40 acquires a plurality of pieces of data to be recorded on the plurality of magnetic tapes T, from the storage unit 22. In step S12, as described above, the control unit 42 divides the storage period into each range R, and derives the total value of the size of the data group for which the storage period is within the range R, as the value V, for each range R.

In step S14, the control unit 42 performs control to record, out of the plurality of pieces of data to be recorded acquired in step S10, a data group in which the value V corresponding to the size of a data group for which the storage period is within the range R is equal to or more than the threshold value TH1 and a data group in which the value V is less than the threshold value TH1, on magnetic tapes T different from each other. At this time, the control unit 42 performs, in a case where there are a plurality of the data groups in which the value V is equal to or more than the threshold value TH1, control to record the plurality of data groups on magnetic tapes T different from each other, respectively. In a case where the processing of step S14 ends, the data recording processing ends.

As described above, according to the present embodiment, it is possible to record data groups for which the storage periods are relatively close to each other and in which the total value of the sizes is equal to or more than the threshold value, on the same magnetic tape. Further, the number of magnetic tapes can be reduced as compared with a case where magnetic tapes are prepared for each fixed range of the storage period determined in advance. Accordingly, the magnetic tape can be efficiently used.

In the above-described embodiment, the case where the total value of the size of the data group for which the storage period is within the range R is applied as the value V has been described, but the present disclosure is not limited thereto. The ratio of the total value of the size of the data group for which the storage period is within the range R to the total value of the sizes of the plurality of pieces of data to be recorded (T1 in the example of FIG. 4) may be applied as the value V.

In the above-described embodiment, the case where the threshold value TH1 is preset has been described, but the present disclosure is not limited thereto. The control unit 42 may set the threshold value TH1 according to the total value of the sizes of the plurality of pieces of data to be recorded. In this case, an aspect is exemplified in which the control unit 42 sets, in a case where the total value of the sizes of the plurality of pieces of data to be recorded exceeds the capacity of the plurality of magnetic tapes T, the threshold value TH1 to a value (for example, a value of 80% of the capacity of one magnetic tape) equal to or less than the capacity of one magnetic tape. Alternatively, in this case, an aspect is exemplified in which the control unit 42 sets, in a case where the total value of the sizes of the plurality of pieces of data to be recorded is a relatively small value which is less than the capacity of one magnetic tape T, the threshold value TH1 to a value (for example, a value of 50% of the total value) less than the total value. The example of this aspect can be applied to a case where a plurality of pieces of data having relatively small sizes are recorded on the plurality of magnetic tapes T, for example, at a periodic timing, such as once a day.

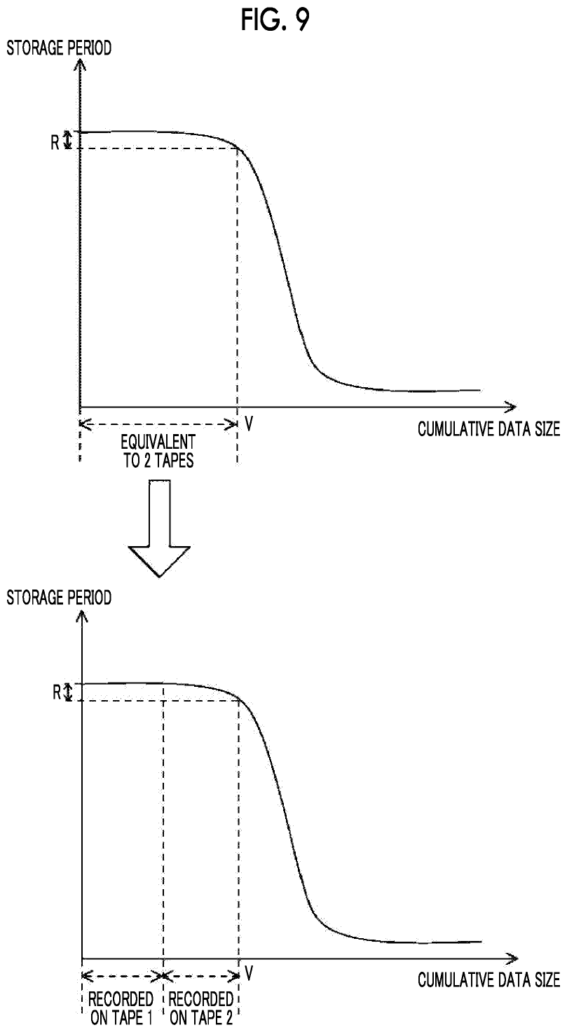

Further, in the above-described embodiment, the control unit 42 may perform, for a data group having a size of which a total value is equal to or more than a second threshold value TH2 which is greater than the threshold value TH1, out of the data group in which the value V is equal to or more than the threshold value TH1, control to narrow the range R and to record the data group on the plurality of magnetic tapes T as in the above-described embodiment. Examples of the threshold value TH2 in this case include a value corresponding to the capacity of the plurality of magnetic tapes T. Specifically, as shown in FIG. 9, an aspect is exemplified in which the control unit 42 performs, for a data group having a size of which the total value (value V) corresponds to the capacity of the plurality of magnetic tapes T, control to divide and record the data group on the plurality of magnetic tapes T. FIG. 9 shows an example in which a data group is recorded on two magnetic tapes T, that is, an example in which the range R is divided into two ranges narrower than the range R.

Further, in the above-described embodiment, for example, as a hardware structure of a processing unit that executes various types of processing, such as the acquisition unit 40 and the control unit 42, the following various processors can be used. The above-described various processors include, for example, a programmable logic device (PLD) which is a processor having a changeable circuit configuration after manufacture, such as a field programmable gate array (FPGA), and a dedicated electrical circuit which is a processor having a dedicated circuit configuration designed to perform specific processing, such as an application specific integrated circuit (ASIC), in addition to the CPU which is a general-purpose processor that executes software (programs) to function as various processing units, as described above.

One processing unit may be composed of one of these various processors or a combination of two or more processors of the same type or different types (for example, a combination of a plurality of FPGAs or a combination of a CPU and an FPGA). Alternatively, a plurality of processing units may be composed of one processor.

A first example in which a plurality of processing units are composed of one processor is an aspect in which one or more CPUs and software are combined to constitute one processor and the processor functions as the plurality of processing units, as typified by a computer, such as a client and a server. A second example is an aspect in which a processor that realizes all the functions of a system including the plurality of processing units with one integrated circuit (IC) chip is used, as typified by a system on chip (SoC). As described above, various processing units are formed of one or more of the above-described various processors as the hardware structure.

Further, as the hardware structure of these various processors, more specifically, an electric circuit (circuitry) in which circuit elements, such as semiconductor elements, are combined can be used.

In the above-described embodiment, the aspect in which the information processing program 30 is stored (installed) in the storage unit 22 in advance has been described, but the present disclosure is not limited thereto. The information processing program 30 may be provided in a form of being recorded on a recording medium, such as a compact disc read only memory (CD-ROM), a digital versatile disc read only memory (DVD-ROM), and a Universal Serial Bus (USB) memory. Alternatively, the information processing program 30 may be downloaded from an external device via the network.

The disclosure of JP2020-048439 filed on Mar. 18, 2020 is incorporated herein by reference in its entirety. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. An information processing device comprising:
at least one processor,
wherein the processor
performs control to record, out of a plurality of pieces of data to be recorded on a plurality of magnetic tapes, a data group in which a value corresponding to a size of a data group for which a storage period is within a predetermined range is equal to or more than a threshold value and a data group in which the value is less than the threshold value, on magnetic tapes different from each other.

2. The information processing device according to claim 1,
wherein the processor performs, in a case where there are a plurality of the data groups in which the value is equal to or more than the threshold value, control to record the plurality of data groups on magnetic tapes different from each other, respectively.

3. The information processing device according to claim 1,
wherein the value corresponding to the size of the data group is a total value of the size of the data group for which the storage period is within the range or a ratio of the total value of the size of the data group for which the storage period is within the range to a total value of sizes of the plurality of pieces of data.

4. The information processing device according to claim 1,
wherein the processor sets the threshold value according to a total value of sizes of the plurality of pieces of data.

5. The information processing device according to claim 1,
wherein the processor performs, for a data group having a size of which a total value is equal to or more than a second threshold value which is greater than the threshold value, out of the data group in which the value is equal to or more than the threshold value, control to narrow the range and to record the data group on the plurality of magnetic tapes.

6. The information processing device according to claim 5,
wherein the processor performs, for a data group having a size of which the total value corresponds to a capacity of the plurality of magnetic tapes, out of the data group in which the value is equal to or more than the threshold value, control to divide and record the data group on the plurality of magnetic tapes.

7. The information processing device according to claim 2,
wherein the value corresponding to the size of the data group is a total value of the size of the data group for which the storage period is within the range or a ratio of the total value of the size of the data group for which the storage period is within the range to a total value of sizes of the plurality of pieces of data.

8. The information processing device according to claim 2,
wherein the processor sets the threshold value according to a total value of sizes of the plurality of pieces of data.

9. The information processing device according to claim 3,
wherein the processor sets the threshold value according to a total value of sizes of the plurality of pieces of data.

10. The information processing device according to claim 7,
wherein the processor sets the threshold value according to a total value of sizes of the plurality of pieces of data.

11. The information processing device according to claim 2,
wherein the processor performs, for a data group having a size of which a total value is equal to or more than a second threshold value which is greater than the threshold value, out of the data group in which the value is equal to or more than the threshold value, control to narrow the range and to record the data group on the plurality of magnetic tapes.

12. The information processing device according to claim 3,
wherein the processor performs, for a data group having a size of which a total value is equal to or more than a second threshold value which is greater than the threshold value, out of the data group in which the value is equal to or more than the threshold value, control to narrow the range and to record the data group on the plurality of magnetic tapes.

13. The information processing device according to claim 4,
wherein the processor performs, for a data group having a size of which a total value is equal to or more than a second threshold value which is greater than the threshold value, out of the data group in which the value is equal to or more than the threshold value, control to narrow the range and to record the data group on the plurality of magnetic tapes.

14. The information processing device according to claim 7,
wherein the processor performs, for a data group having a size of which a total value is equal to or more than a second threshold value which is greater than the threshold value, out of the data group in which the value is equal to or more than the threshold value, control to narrow the range and to record the data group on the plurality of magnetic tapes.

15. The information processing device according to claim 8,
wherein the processor performs, for a data group having a size of which a total value is equal to or more than a second threshold value which is greater than the threshold value, out of the data group in which the value is equal to or more than the threshold value, control to narrow the range and to record the data group on the plurality of magnetic tapes.

16. The information processing device according to claim 9,
wherein the processor performs, for a data group having a size of which a total value is equal to or more than a second threshold value which is greater than the threshold value, out of the data group in which the value is equal to or more than the threshold value, control to narrow the range and to record the data group on the plurality of magnetic tapes.

17. The information processing device according to claim 10,
wherein the processor performs, for a data group having a size of which a total value is equal to or more than a second threshold value which is greater than the threshold value, out of the data group in which the value is equal to or more than the threshold value, control to narrow the range and to record the data group on the plurality of magnetic tapes.

18. An information processing method executed by a processor provided in an information processing device, the method comprising:
performing control to record, out of a plurality of pieces of data to be recorded on a plurality of magnetic tapes, a data group in which a value corresponding to a size of a data group for which a storage period is within a predetermined range is equal to or more than a threshold value and a data group in which the value is less than the threshold value, on magnetic tapes different from each other.

19. A non-transitory computer-readable storage medium storing an information processing program for causing a processor provided in an information processing device to execute a process comprising:
performing control to record, out of a plurality of pieces of data to be recorded on a plurality of magnetic tapes, a data group in which a value corresponding to a size of a data group for which a storage period is within a predetermined range is equal to or more than a threshold value and a data group in which the value is less than the threshold value, on magnetic tapes different from each other.
